(19) United States
(12) Patent Application Publication
(10) Pub. No.: US 2008/0220935 A1
(43) Pub. Date: Sep. 11, 2008

(54) Hydraulic system for controlling a belt-driven conical-pulley transmission

(75) Inventors: Roshan Willeke, Karlsruhe (DE); Eric Muller, Kaiserslautern (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/072,136

(22) Filed: Feb. 21, 2008

Related U.S. Application Data
(60) Provisional application No. 60/902,561, filed on Feb. 21, 2007.
(60) Provisional application No. 60/902,562, filed on Feb. 21, 2007.
(60) Provisional application No. 60/902,563, filed on Feb. 21, 2007.
(60) Provisional application No. 60/919,398, filed on Mar. 22, 2007.
(60) Provisional application No. 60/937,273, filed on Jun. 26, 2007.
(60) Provisional application No. 60/937,274, filed on Jun. 26, 2007.
(60) Provisional application No. 60/937,275, filed on Jun. 26, 2007.
(60) Provisional application No. 60/937,276, filed on Jun. 26, 2007.

(51) Int. Cl. F16H 61/662; F16H 61/00; B60K 17/06

(52) U.S. Cl. 477/49; 474/28; 180/366

(57) ABSTRACT

A hydraulic system for controlling a belt-driven conical-pulley transmission of a motor vehicle, wherein the transmission has a variably adjustable transmission ratio. The hydraulic system includes a first valve arrangement to control a contact pressure in the belt-driven conical-pulley transmission, a second valve arrangement to control the transmission ratio of the belt-driven conical-pulley transmission, and a hydraulic energy source to supply the hydraulic system with hydraulic energy. In order to provide an improved hydraulic system, the system includes a third valve arrangement for controlling a forward clutch and a reverse clutch.

### BACKGROUND OF THE INVENTION

1. Field of the Invention

The present invention relates to a hydraulic system for controlling a belt-driven conical-pulley transmission (CVT) of a motor vehicle having a variably adjustable transmission ratio. The hydraulic system includes a first valve unit to ensure a contact pressure of the belt-driven conical-pulley transmission, a second valve unit to control the transmission ratio of the belt-driven conical-pulley transmission, and a hydraulic energy source to supply the hydraulic system with hydraulic energy. The present invention also relates to a belt-driven conical-pulley transmission controlled thereby and to a motor vehicle equipped therewith.

2. Description of the Related Art

Belt-driven conical-pulley transmissions can have a continuously variable transmission ratio, in particular automatically effected transmission ratio variation.

Such continuously variable automatic transmissions include, for example, a startup unit, a reversing planetary gearbox as the forward/reverse drive unit, a hydraulic pump, a variable speed drive unit, an intermediate shaft, and a differential. The variable speed drive unit includes two pairs of conical disks and an encircling member. Each conical disk pair includes one conical disk that is movable in an axial direction. Between the pairs of conical disks runs the encircling element, for example a steel thrust belt, a tension chain, or a drive belt. Axially moving the movable conical disk changes the running radius of the encircling member, and thus the transmission ratio of the continuously variable automatic transmission.

Continuously variable automatic transmissions require a high level of contact pressure applied to the encircling member in order to be able to move the axially movable conical disks of the variable speed drive unit with the desired speed at all operating points, and also to transmit the torque with sufficient basic pressure with minimum wear.

An object of the present invention is to provide a hydraulic system for a belt-driven conical-pulley transmission and/or a belt-driven conical-pulley transmission that includes a hydraulic shift-by-wire control and that can replace mechanical actuation of the parking lock and the clutch selection.

### SUMMARY OF THE INVENTION

The above-identified object is achieved with a hydraulic system in accordance with the present invention for controlling a belt-driven conical-pulley transmission of a motor vehicle having a variably adjustable transmission. The hydraulic system includes a first valve arrangement to ensure a desired belt contact pressure in the belt-driven conical-pulley transmission, a second valve arrangement to control the transmission ratio of the belt-driven conical-pulley transmission, a hydraulic energy source to supply the hydraulic system with hydraulic energy, and a third valve arrangement to control a forward and a reverse clutch. The forward clutch and the reverse clutch are parts of a power train of the motor vehicle, and can optionally be actuated by means of the third valve arrangement, wherein the motor vehicle moves forward when the forward clutch is actuated and the motor vehicle moves backward when the reverse clutch is actuated. A mechanical intervention by means of a gearshift lever operable by a driver of the motor vehicle, for example, is not necessary to engage the forward or reverse gear of the motor vehicle.

The above-identified object is also achieved with a hydraulic system in accordance with the present invention for controlling a belt-driven conical-pulley transmission of a motor vehicle having a variably adjustable transmission. The hydraulic system includes a first valve arrangement to ensure a desired belt contact pressure in the belt-driven conical-pulley transmission, a second valve arrangement to control the transmission ratio of the belt-driven conical-pulley transmission, a hydraulic energy source to supply the hydraulic system with hydraulic energy, by providing a parking lock-release system to control a parking lock. The parking lock is normally produced by a mechanical intervention of an appropriate component, for example a pawl, in the power train of the motor vehicle. Advantageously, the mechanical lock can be actuated, i.e., engaged or released again, for example, by means of the parking lock-release system. A mechanical intervention that would require comparatively high manual force from a driver of the motor vehicle to operate the parking lock is not necessary.

A preferred exemplary embodiment of the hydraulic system is characterized in that the third valve arrangement includes a first valve having a first control piston for hydraulic actuation of the forward and reverse clutches. By means of the first control piston, the forward and the reverse clutch can optionally be supplied with hydraulic energy to engage or disengage them, or can be cut off from the hydraulic energy source.

Another preferred exemplary embodiment of the hydraulic system is characterized in that the hydraulic parking-lock-release system includes a second valve for hydraulic actuation of a parking lock cylinder positioned downstream from the second valve, for mechanical control of the parking lock. The parking lock cylinder can be connected mechanically to the power train of the motor vehicle. To that end, a lever connected to a transmission shaft can be engaged with a corresponding recess of the parking lock cylinder, for example.

Another preferred exemplary embodiment of the hydraulic system is characterized in that the third valve arrangement includes a third valve positioned upstream from the first valve to actuate the first control piston of the first valve. The third valve can be a control valve, for example an electrically actuatable proportional valve. By means of the actuation by the third valve, the forward or the reverse gear of the motor vehicle can optionally be engaged by selective actuation of the forward or reverse clutch.

Other preferred exemplary embodiments of the hydraulic system are characterized in that by means of the first control piston of the first valve
a first selector position (R) to apply pressure to the reverse clutch and switch the forward clutch to zero pressure,
a second selector position (N) to switch the forward and reverse clutches to zero pressure, and
a third selector position (D) to apply pressure to the forward clutch and switch the reverse clutch to zero pressure

are optionally alternatively actuatable.

The forward and reverse clutches can be clutches that are disengaged when unpressurized. However, it is also conceivable to design the reverse and forward clutches so that they are engaged when unpressurized. Accordingly, in the second selector position the control piston can be switched so that both clutches are under pressure. When the forward and reverse clutches are designed as clutches that are disengaged when unpressurized, the result is a safety benefit, since in the event of a possible occurrence of a pressure loss of the hydraulic energy source, the neutral position results without further action, i.e., unpressurized forward and reverse clutches, wherein the vehicle can continue to move in free wheeling.

Another preferred exemplary embodiment of the hydraulic system is characterized in that a sensor system is provided to detect the first through third selector positions (R, N, D) of the first control piston. Advantageously, by means of the sensor system the actual shift states of the first control piston can be recognized and transmitted for further processing. The data thus obtained can be used for a display of the selector position actually chosen, for example. From the aspect of safety, it is possible to use the data obtained to recognize possibly unwanted intermediate conditions, or an unwanted selector position. For example, if an unwanted selector position results, that can be utilized to initiate an emergency function, for example emergency shutoff.

Another preferred exemplary embodiment of the hydraulic system is characterized in that the sensor system includes a Hall-effect sensor to detect a position of the first control piston. The Hall-effect sensor can be employed as an additional safety device, and it can operate together with a corresponding magnet attached to the first control piston, for example. The Hall-effect sensor, as an additional part of the sensor system, can generate other safety-relevant information.

Another preferred exemplary embodiment of the hydraulic system is characterized in that the first valve is connected upstream to the hydraulic energy source through a fifth valve. The supply of hydraulic energy to the first valve can be controlled by means of the fifth valve.

Another preferred exemplary embodiment of the hydraulic system is characterized in that the first valve is connected downstream to a sixth valve to actuate the fifth valve. The fifth valve can be actuated by means of the sixth valve, which can be designed as a control valve, for example as an electrically actuatable proportional valve. It is conceivable to design the fifth valve so that when actuated accordingly it completely separates the first valve from the hydraulic energy source by means of the sixth valve, and at the same time switches the first valve to tank. That can be used advantageously as an emergency shutoff, where the reverse clutch and the forward clutch can be switched to zero pressure and therefore disengage, with the belt-driven conical-pulley transmission being shifted automatically to the neutral position. As an additional safety provision, it is conceivable to design the first control piston of the first valve so that in the unpressurized state, i.e., without control pressure from the third valve, it moves automatically into a selector position in which the forward and reverse clutches are switched to zero pressure.

Another preferred exemplary embodiment of the hydraulic system is characterized in that to actuate the second valve the second control piston is connected to the hydraulic energy source through the fifth valve. The fifth valve can serve to control the second valve, whereupon a connection to the hydraulic energy source can bring about a release of the parking lock. Advantageously, the fifth valve is also connected ahead of the first valve for clutch actuation. Advantageously, raising the pressure for the first valve to engage one of the clutches also acts through the second valve to bring about a release of the parking lock. That advantageously ensures that when the clutch is engaged or as the clutch is engaging, the parking lock is released.

Another preferred exemplary embodiment of the hydraulic system is characterized in that the second valve includes hydraulic self-retention. The parking lock can be released by means of the hydraulic latching feature, even when the control pressure is dropping. That advantageously ensures that the hydraulic parking lock remains unlocked as long as the hydraulic energy source is also supplying hydraulic energy, for example in the case of a mechanically driven pump, i.e., one that is connected to the internal combustion engine of the motor vehicle.

Another preferred exemplary embodiment of the hydraulic system is characterized in that the second valve arrangement includes a seventh valve to adjust the transmission ratio. Corresponding adjusting elements of the belt-driven conical-pulley transmission can be controlled by means of the second valve arrangement to adjust the transmission ratio.

Another preferred embodiment of the hydraulic system is characterized in that a first flow chamber and a second flow chamber of the seventh valve are selectively variably connected to set the transmission ratio and to the hydraulic energy source or to the tank. The requisite pressure to set the transmission ratio can be applied to the adjusting elements via the first and second flow chambers.

Another preferred exemplary embodiment of the hydraulic system is characterized in that the first and the second flow chambers are connected to the second valve downstream through an OR element to achieve the hydraulic self-retention. A corresponding pressure surface of the second control piston can advantageously be subjected to pressure through the OR element, it being sufficient that one of the two flow chambers is pressurized.

Another preferred exemplary embodiment of the hydraulic system is characterized in that the first and the second flow chambers are connected downstream through the OR element and the second valve in the parking-lock release cylinder. By means of the latching feature and the OR element, the parking-lock release cylinder can be pressurized so that the parking lock can be released. The pressure to release the parking lock is provided by the first or second flow chamber of the seventh valve.

Another preferred exemplary embodiment of the hydraulic system is characterized in that the first and second flow chambers of the seventh valve are connected to the tank through a ninth valve to raise the tank pressure. An increase in tank pressure can be achieved by means of the ninth valve.

Another preferred exemplary embodiment of the hydraulic system is characterized in that a ninth control piston of the ninth valve is actuatable through a fourth valve. The fourth valve can be a control valve, for example an electrically actuatable proportional valve.

Another preferred exemplary embodiment of the hydraulic system is characterized in that the ninth valve arrangement includes control stages to control the increase in tank pressure. The magnitude of the increase in tank pressure can advantageously be set by means of the control stages.

Another preferred exemplary embodiment of the hydraulic system is characterized in that a tenth valve with a tenth control piston is connected downstream from the hydraulic energy source for prioritized supplying of the hydraulic system with hydraulic energy. The tenth valve can supply the downstream components of the hydraulic system with hydraulic energy in accordance with a desired priority.

Another preferred exemplary embodiment of the hydraulic system is characterized in that with a first, small amount of energy only the first valve arrangement is supplied by means of the hydraulic energy source, and with a second, larger amount of energy additional components of the hydraulic system are also supplied. Advantageously, that makes it possible to ensure that when the internal combustion engine of the motor vehicle is started the necessary contact pressure in the transmission can be supplied first.

Another preferred exemplary embodiment of the hydraulic system is characterized in that with a third amount of energy, greater than the second amount, the components of the hydraulic system are supplied with limited hydraulic energy. To that end the tenth valve can divert surplus hydraulic medium directly into the tank circuit, to thereby prevent the pressures in the remainder of the downstream system from getting too high when the hydraulic energy source is rotating rapidly, i.e., when large volumetric flows are being transported.

Another preferred exemplary embodiment of the hydraulic system is characterized in that a fourth valve arrangement is provided to control a volumetric flow of cooling oil, in particular to cool the clutches. Components of the power train, for example the forward and reverse clutches, a centrifugal oil cover, and/or conical disks, as well as encircling elements of the belt-driven conical-pulley transmission, can advantageously be subjected to a controlled volumetric flow of cooling oil by means of the fourth valve arrangement.

Another preferred exemplary embodiment of the hydraulic system is characterized in that the fourth valve arrangement includes the fourth valve for actuation. The fourth valve can thus simultaneously actuate the ninth control piston of the ninth valve and the fourth valve arrangement. Advantageously, the fourth valve can be so designed as a proportional valve. It is conceivable to design the fourth valve as a proportional valve, in which case the valves connected downstream are actuatable by just one valve. To that end the control surfaces and return springs of the actuated valves can be designed accordingly and can respond in various ranges, for example.

The object is also achieved with a belt-driven conical-pulley transmission having a hydraulic system of the type described above.

The object is also achieved with a motor vehicle having a belt-driven conical-pulley transmission and a hydraulic system of the type described above.

### BRIEF DESCRIPTION OF THE DRAWINGS

The structure, operation, and advantages of the present invention will become further apparent upon consideration of the following description taken in conjunction with the accompanying drawings, in which:

FIG. 1 is a hydraulic circuit diagram of an embodiment of a hydraulic system in accordance with the present invention for controlling a belt-driven conical-pulley transmission;

FIG. 2 is a diagram of a shared-use proportional valve for actuating a tank pressure increase and a cooling oil quantity;

FIG. 3 is a schematic view of a parking-lock release system actuated by the hydraulic system;

FIG. 4 is schematic view of three different regulating or control positions of a valve connected downstream from a hydraulic energy source for prioritized supply to downstream components;

FIG. 5 is a of volumetric flow as a function of rotational speed of the hydraulic energy source for the valve shown in FIG. 4; and

FIG. 6 is a longitudinal cross-sectional view of a first valve for actuating a forward and a reverse clutch, with a Hall-effect sensor for detecting a position of a first control piston of the first valve.

### DESCRIPTION OF THE PREFERRED EMBODIMENTS

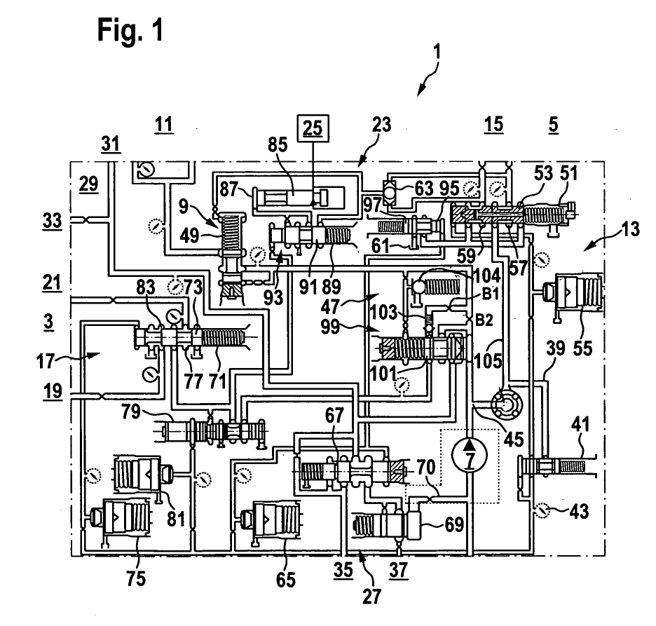

FIG. 1 shows a circuit diagram of a portion of a hydraulic system 1. Hydraulic system 1 is used to control a belt-driven conical-pulley transmission, which is indicated generally by reference numeral 3 in FIG. 1. Belt-driven conical-pulley transmission 3 can be part of a power train of a motor vehicle 5, which is indicated generally by reference numeral 5. Hydraulic system 1 includes a hydraulic energy source 7, for example a mechanically or electrically driven hydraulic pump for delivering a hydraulic medium. For powering the hydraulic energy source 7 it can be connected to an internal combustion engine (not shown in greater detail) of the motor vehicle 5. Hydraulic energy source 7 serves to supply hydraulic system 1 with hydraulic energy in the form of pressurized hydraulic fluid.

Connected downstream from hydraulic energy source 7 is a first valve arrangement 9, which is connected to a torque sensor 11. First valve arrangement 1 and torque sensor 11 serve to provide and/or control a contact pressure for transmitting torque between conical disk pairs and a corresponding encircling element of belt-driven conical-pulley transmission 3, in particular as a function of the torque present at the input side of the belt-driven conical-pulley transmission 3. Downstream, torque sensor 11 is connected to a cooler return 31 through a cooler (not shown). Torque sensor 11 can raise or lower a system pressure 45 delivered by the hydraulic energy source, as a function of the torque that is present.

A second valve arrangement 13 is also connected downstream from hydraulic energy source 7. Second valve arrangement 13 is connected to conical disk pairs indicated generally by reference numeral 15, and serves to adjust the positions of the conical disks 15, i.e., to set the transmission ratio of belt-driven conical-pulley transmission 3.

Also connected downstream from hydraulic energy source 7 is a third valve arrangement 17, which is connected to actuate a forward clutch 19 and a reverse clutch 21, and which are only generally indicated by their respective reference numerals.

A hydraulic parking-lock release system 23 is also connected downstream from hydraulic energy source 7. The parking-lock release system 23 of hydraulic system 1 is connected to a mechanical parking lock 25 indicated generally by reference numeral 25. The connection can be effected by means of suitable mechanical aids, for example a lever. By means of the parking-lock release system 23, the mechanical parking lock 25 of motor vehicle 5 can be engaged, i.e., established, and released again.

Hydraulic energy source 7 also serves to supply a fourth valve arrangement 27. Fourth valve arrangement 27 serves to provide a volumetric flow of cooling oil that is likewise provided by means of hydraulic energy source 7. To that end, fourth valve arrangement 27 is connected to a cooling circuit generally indicated by reference numeral 29, in particular to the cooler return 31, to an active Hytronic cooling system 33, to a jet pump 35, and to a centrifugal oil cover 37, each of which is only generally indicated by its respective reference numeral.

Hydraulic energy source 7 is connected downstream through a branch 39 to a pilot-pressure regulating valve 41. Pilot-pressure regulating valve 41 regulates a downstream pilot pressure 43, for example of around 5 bar, while the hydraulic energy source 7 provides a higher system pressure 45. The pilot pressure serves in a known way by means of suitable proportional valves, for example electrically actuatable proportional valves, to control the circuit components of hydraulic system 1.

To adjust and distribute the hydraulic energy supplied by hydraulic energy source 7, a fifth valve arrangement 47 is provided. Fifth valve arrangement 47 ensures priority supply to the torque sensor 11 and to the second valve arrangement 13, for example when starting the engine of the motor vehicle 5. In addition, it conducts the excess volumetric flow of the hydraulic energy source directly in the direction of the cooler return 31.

To set or regulate the system pressure 45 upstream of torque sensor 11, the latter includes pressure regulating valves (not shown). First valve arrangement 9 includes a system pressure valve 49 connected upstream of torque sensor 11. System pressure valve 49 is connected downstream from fifth valve arrangement 47, and allows passage of an appropriate volumetric flow for torque sensor 11, while the system pressure 45 downstream can be adjusted to a minimum system pressure, for example 6 bar. To set the adjusting pressure through short-term additional elevation of the system pressure 45, system pressure valve 49 is additionally connected upstream to second valve arrangement 13 through an OR element 63.

Second valve arrangement 13 includes a seventh valve 51 having a seventh control piston 53 and connected downstream from hydraulic energy source 7. Seventh control piston 53 is connected upstream to an eighth valve 55 for actuation. The eighth valve 55 can be a control valve, for example an electrically actuatable proportional valve. Seventh valve 51 includes a first flow chamber 57 and a second flow chamber 59, which are each connected to corresponding adjusting elements of the conical disks 15. By means of the seventh control piston 53 of the seventh valve 51, hydraulic energy source 7 can optionally be connected continuously, i.e., with transfer flow, to first flow chamber 57 or to second flow chamber 59. The particular flow chamber that is not connected to the hydraulic energy source 7 can accordingly be connected to a tank 61. In a middle position, both flow chambers 57 and 59 can be disconnected from the hydraulic energy source 7 and switched to the tank 61. Thus a desired pressure ratio can be set in flow chambers 57 and 59 by means of the seventh valve 51 of second valve arrangement 13 to adjust the conical disks 15. In addition, flow chambers 57 and 59 are connected to system pressure valve 49 through the OR element 63 upstream of the latter. Through that connection, the minimum system pressure, adjusted by means of system pressure valve 49, can be adjusted by a desired amount to the seventh valve 51, i.e., for example raised, by means of adjusting motions made by means of the latter.

Fourth valve arrangement 27 includes a cooling oil regulating valve 67 that is actuated by means of a fourth valve 65. Cooling oil regulating valve 67 is connected downstream from the fifth valve arrangement 47, and is supplied thereby with hydraulic energy by means of hydraulic energy source 7. In addition, fourth valve arrangement 27 includes a return valve 69, which is connected upstream directly to hydraulic energy source 7 or to a pump injector 70 of hydraulic energy source 7. Return valve 69 is connected downstream with a through connection to centrifugal oil cover 37 through a flow chamber of return valve 69, and as the volumetric flow rises it conveys a partial flow directly into the pump injector 70. Cooling oil regulating valve 67 serves to maintain and regulate a desired cooling oil volumetric flow through jet pump 35 to the components to be cooled, forward clutch 19 and reverse clutch 21.

The third valve arrangement 17 includes a first valve 71 having a first control piston 73. To actuate the first control piston 73, the latter is connected downstream to a third valve 75, for example a control valve such as an electrically actuatable proportional valve. The first control piston 73 of the first valve 71 can assume essentially three selector positions to actuate the forward clutch 19 and the reverse clutch 21. In a first selector position, which is shown in FIG. 1, in which the reverse clutch 21 is pressurized, a first flow chamber 77 of the first valve 71 is connected to the hydraulic energy source 7 by means of first control piston 73, the connection to the hydraulic energy source 7 being accomplished through a fifth valve 79. Fifth valve 79 is actuatable by means of a sixth valve 81, for example a control valve such as an electrically actuatable proportional valve, and serves to provide or control and/or regulate a pressure to engage the clutches 19 and 21, which are selectively connected downstream. If a torque to be transmitted is present, the pressure can be up to 20 bar, for example. Advantageously, the fifth valve 79 can be used in addition, for example in the event of a problem, preferably in the case of an electric power failure, to switch the downstream first valve 71 to zero pressure, i.e., to separate the hydraulic energy source 7 from the first valve 71. Preferably, to that end both the inlet of the first valve 71 and the hydraulic energy source 7 can be switched to the tank 61.

In a second selector position, which corresponds to a displacement of the first control piston 73 of first valve 71 to the right, as viewed in the orientation shown in FIG. 1, the connection to the fifth valve 79, connected upstream, can be interrupted. At the same time, the first flow chamber 77 can be switched to the tank 61 by means of the first control piston 73 of first valve 71, so that the reverse clutch is de-pressurized. In addition, in that selector position the forward clutch 19 can also be switched to the tank 61 via a second flow chamber 83 of first valve 71.

In a third selector position, which corresponds to a further displacement of first control piston 71 to the right, as viewed in the orientation shown in FIG. 1, the second flow chamber 83 can be connected to the fifth valve 79 and the first flow chamber 77 to the tank 61. In that third selector position, which corresponds to an engaged forward gear of the motor vehicle 5, the forward clutch 19 is thus under pressure and the reverse clutch 21 is switched to zero pressure.

The parking-lock release system 23 includes a parking lock cylinder 85. Parking lock cylinder 85 can be biased toward the left, as viewed in the orientation shown in FIG. 1, by means of a return spring of the parking lock (not shown). Parking lock cylinder 85 can be moved to the right against that spring bias, as viewed in the orientation shown in FIG. 1, to release the parking lock 25. To apply the appropriate hydraulic force, one end face 87 of parking lock cylinder 85 is connected downstream from a second valve 89 of the parking lock-release system 23. To increase the system pressure 45 during the release of the parking lock 25, it is conceivable to simultaneously operate the seventh valve 51 of the second valve arrangement 13 in any desired adjustment direction, whereby the system pressure 45 is increased through the downstream-connected OR element and the system pressure valve 49, to up to 50 bar, for example.

The second valve 89 includes a second control piston 91. The second control piston 91 includes a hydraulic latching feature 93. Using the hydraulic latching feature, a pressure that is present at the end face 87 of the parking lock cylinder 85 is recirculated to a second pressure surface of the second control piston 91, the latter being held in its open position by that recycling, in particular in the event that there is no longer a control pressure present at the second control piston 91 through the fifth valve 79. The pressure is then supplied, with the second control piston 91 moved to the right as viewed in the orientation shown in FIG. 1, through a control groove of the second control piston 91, which then at an upstream location connects the OR element 63 with the end face 87 of the parking lock cylinder 85. The necessary pressure to achieve the hydraulic latching feature 93 is thus switched from the first flow chamber 57 or the second flow chamber 59 to the end face 87. Nevertheless, in order to still have enough pressure available at a zero crossing of the seventh control piston 53 of the seventh valve 51, at which theoretically both flow chambers 57 and 59 are connected to the tank 61, flow chambers 57 and 59 are connected to tank 61 downstream through a ninth valve 95.

Ninth valve 95 includes a ninth stepped control piston 97. Flow chambers 57 and 59 can be connected to tank 61 with a variable pressure drop via the steps of the stepped ninth control piston 97, so that a minimum pressure, for example 6 bar, exists in flow chambers 57 and 59, even at the zero crossing. For actuation, the ninth valve 95 is connected to the fourth valve 65, which also actuates cooling oil regulating valve 67. Cooling oil regulating valve 67 and ninth valve 95 are thus equally actuated by fourth valve 65. In principle, it is conceivable to design the control surfaces and/or directions of action of valves 67 and 95 differently. Valves 67 and 95 can be designed with different response thresholds, so that in a first response range, for example, a tank pressure increase results when the cooling is on, in a second response range there is no tank pressure increase but there is cooling, and in a third response range there is no tank pressure increase and no cooling occurs.

For prioritized supply of valve arrangements 9, 13 and of torque sensor 11 before valve arrangements 17, 27, hydraulic system 1 includes a tenth valve 99 having a tenth control piston 101. Tenth valve 99 operates together with an orifice plate B1, an orifice plate B2, a check valve 103, and a pressure relief valve 104. Orifice plate B1 allows a greater volumetric flow, for example 15 l/min, than orifice plate B2, for example 3 l/min. When the volumetric flow is comparatively low, torque sensor 11 is supplied with hydraulic energy through orifice plate B2. In addition, second valve arrangement 13 is likewise supplied with hydraulic energy with first priority by way of a branch 105. As the delivery volume increases, tenth control piston 101 moves to the left, as viewed in the orientation shown in FIG. 1, whereby in addition the third valve arrangement 17 is supplied with hydraulic energy. In addition, through the opening of check valve 103 and the orifice plate B1, torque sensor 11 is supplied with a greater volumetric flow, which corresponds to the sum of the volumetric flows of orifice plates B1 and B2. With a third, even greater volumetric flow, hydraulic energy source 7 is in addition connected to the cooling circuit 29. That enables the remainder of the hydraulic system 1 to be supplied with a limited amount of hydraulic energy.

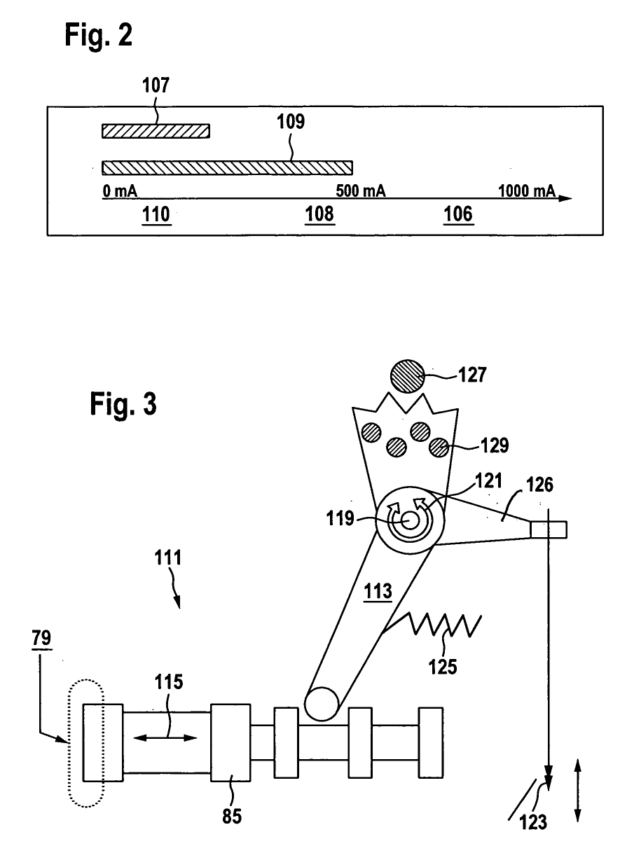

FIG. 2 shows a diagram for applying a control current of between zero and 1000 milliamperes to fourth valve 65, and a schematic representation of the response behavior of the cooling oil regulating valve 67 actuated thereby and of the ninth valve 95 for increasing the tank pressure. A first bar 107 between zero and 250 milliamperes indicates the first response range 110 of ninth valve 95. A second bar 109, shown in FIG. 2 below first bar 107, between zero and 500 milliamperes, indicates the second response range 108 of cooling oil regulating valve 67. A third range 106 between 500 and 1000 milliamperes of control current of the fourth valve 65 is equivalent to a fully displaced ninth control piston 97 and a fully displaced control piston of cooling oil regulating valve 67. In that third range 106 there is no increase of tank pressure and no cooling. In second range 108 between 250 and 500 milliamperes, ninth control piston 97 is already in a stop position, while cooling oil regulating valve 67 is still in a control position. So in that second range 108 no increase in tank pressure occurs, but a volumetric flow of cooling oil can still be regulated through cooling oil regulating valve 67. In first range 110 between zero and 250 milliamperes, the control piston of cooling oil regulating valve 67 is already in its stop position because of the spring force, which corresponds to the unpressurized state. That unpressurized state of cooling oil regulating valve 67 means that the cooling system is subjected to a maximum volumetric flow of cooling oil. In order to achieve that, cooling oil regulating valve 67 can be so designed as to be opposite the representation shown in FIG. 1. In the first range 110, in which the cooling system is switched on at full strength, the tank pressure increase can be set between zero and maximum by means of the actuation of the ninth control piston 97 of the ninth valve 95.

FIG. 3 shows a schematic view of a parking-lock release system 111, with the second control piston 91 of the second valve 89 being indicated schematically. It is evident that a lever 113 of a mechanism of the parking-lock release system 111 is mechanically engaged with the parking lock cylinder 85. A movement of the parking lock cylinder 85 to the right or left, as viewed in the orientation shown in FIG. 3 and indicated by a double-headed arrow 115, and actuated by means of the fifth valve 79, causes a rotary motion of a selector shaft 119, indicated by a curved double-headed arrow 121. To release a parking pawl 123, the parking lock cylinder 85 can be moved to the right, as viewed in the orientation shown in FIG. 3, while selector shaft 119 can be rotated counter-clockwise, whereupon parking pawl 123 is actuatable by means of another lever 126. The energy needed for that operation, which can be comparatively high in the case of a vehicle 5 parked on a slope, for example, can be delivered by actuating the fifth valve 79 with the system pressure 45.

To detect the position of parking pawl 123, a position sensor 127 can be provided, which interacts by means of magnets 129, for example, that are operatively associated with the selector shaft 119. The selector position of the parking pawl 123 can be determined by means of the position sensor 127 and the magnets 129.

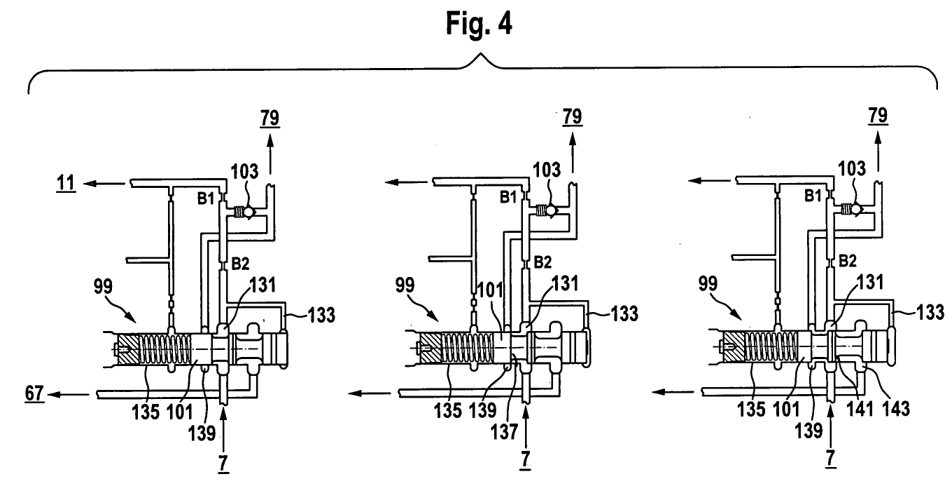

FIG. 4 shows another exemplary embodiment and a possible interconnection of the tenth valve 99. FIG. 4 shows tenth valve 99 in three different states; in a first state, shown to the left in FIG. 4, tenth control piston 101 is in a right-hand position, where the hydraulic energy source 7 is connected directly to torque sensor 11 through a third flow chamber 131, orifice plate B2, and orifice plate B1. As the volumetric flow rises, a pressure builds up ahead of orifice plate B2, which is conducted to the rightmost end of tenth control piston 101 by means of a return line 133, so that control piston 101 moves to the left against the force of a return spring 135 of tenth valve 99.

In a second selector position of tenth valve 99, shown in the center of FIG. 4, tenth control piston 101 is displaced slightly to the left, so that a first control edge 137 opens hydraulic energy source 7 toward the fifth valve 79 through a fourth flow chamber 139. In that control piston position, the energy supplied by hydraulic energy source 7 flows through orifice plate B2, through check valve 103, and through orifice plate B1 to torque sensor 11 and to fifth valve 79.

As shown to the right in FIG. 4, if the volumetric flow supplied by hydraulic energy source 7 exceeds a certain magnitude, combined with a second pressure increase, a second control edge 141 of the tenth control piston 101 opens the third flow chamber 131 to communicate with a fifth flow chamber 143 of the tenth valve 99 in a third selector position. The fifth flow chamber 143 is connected to the cooling circuit 29 or to the cooling oil regulating valve 67, which enables the hydraulic energy source 7 to release excess volumetric flow to the cooling oil circuit 29.

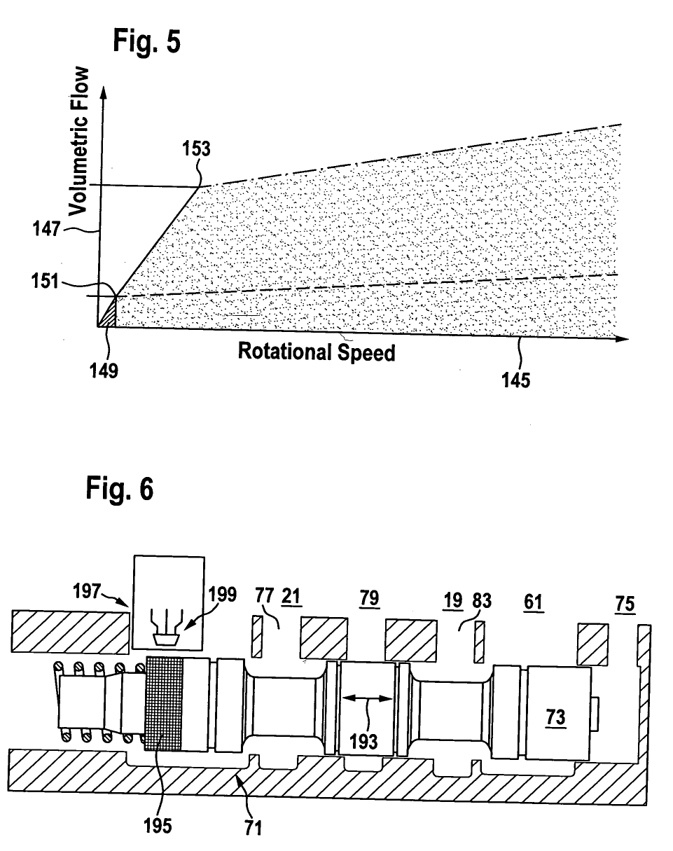

FIG. 5 is a graph showing the supply behavior of tenth valve 99. In the graph shown in FIG. 5, a rotational speed of hydraulic energy source 7, for example a rotational speed of a connected internal combustion engine, is plotted on X-axis 145. A volumetric flow regulated by means of the tenth valve 99 is plotted on Y-axis 147. A first shaded area 149, which corresponds in FIG. 4 to the first selector position, shows the basic supply with first priority of the torque sensor 11. At a first switching point 151, which corresponds to the orientation shown in the center of FIG. 4, the other components of the hydraulic system 1 are also connected. As the speed of rotation increases, the volumetric flow rises in a straight line from the first switching point 151 to a start of speed regulation 153, which corresponds to the representation on the right in FIG. 4. Beyond the start of speed regulation 153, the excess volumetric flow is routed to the cooling oil circuit 29.

FIG. 6 shows a longitudinal cross-sectional view of first valve 71 having the first control piston 73, shown in FIG. 1. First control piston 73 can be moved to the right and left, as indicated by a double-headed arrow 193 in FIG. 6, to adjust the clutches 21 and 19. It can be seen in FIG. 6 that first control piston 73 includes a ring magnet 195, which can operate together with a sensor 199 to achieve a sensor system 197 to detect a position of first control piston 73. Sensor 199 can be a Hall-effect sensor, for example, which is positioned tangentially to ring magnet 195. The position of first control piston 73 shown in FIG. 6 can be detected exactly by means of sensor 199, for example. The position of first control piston 73 shown in FIG. 6 corresponds to a neutral position (N) of the belt-driven conical-pulley transmission 3, with the forward clutch 19 and the reverse clutch 21 blocked from the fifth valve 79. It is conceivable to exchange the actuation of the clutches 19 and 21.

It is possible by means of the hydraulic system shown in FIGS. 1 through 6 to replace formerly necessary manual selectors for clutch selection by the pilot-operated first control piston 73. The overall result is a hydraulic system 1 that requires the least possible construction space and a small number of solenoids and selector valves.

Fourth valve 65 is connected upstream of cooling oil regulating valve 67 and ninth valve 95.

Parking lock cylinder 85 operates against an externally applied parking pawl 123 and engagement spring 125, which urges the parking lock cylinder 85 back into its initial position at the zero pressure position. Advantageously, a comparatively large force can be achieved by applying the comparatively high system pressure 45, resulting in reliable disengagement of the parking lock 25.

Advantageously, in the event of an electric power failure both clutches can be switched to zero pressure automatically by means of fifth valve 79, while at the same time parking lock 25 can be released hydraulically, since in that case second valve 89 also automatically switches parking lock cylinder 85 to the tank 61 so that the motor vehicle 5 is secured against unintended rolling away.

As an additional safety monitoring element, first control piston 73 includes sensor 199, for example a Hall-effect sensor. The sensor 199 shown in FIG. 6 reports to a control device provided to control hydraulic system 1 the position of first control piston 73, or also a direction of motion of control piston 73 when selecting the clutch. That makes it possible to detect an incorrect selection of the clutches 19 and 21 and/or a hanging of first control piston 73. Other sensors can be provided in addition to sensor 199, if necessary. In addition, the selected actuation of third valve 75 in normal operation can enable conclusions to be drawn about the position of first control piston 73.

Hydraulic system 1 in accordance with the invention provides the following functions for the hydraulic control: hydraulic actuation and selection of the forward and reverse clutch, cooling the clutch, moving the pulleys of the CVT transmission, biasing the pulleys of the CVT transmission, providing a volumetric flow of oil through the cooler, and actuation (releasing) of the parking lock. Advantageously, it is possible to replace a previously employed “manual” selector (clutch selection) with a pilot-operated selector. At the same time, a parking-lock release system can be added. Advantageously, comparatively few solenoids and selector valves are needed, enabling savings in both construction space and cost aspects.

In summary, the following are included: a modified clutch actuating system and the actuation of the parking-lock release system 111 or parking lock 25, the prioritizing tenth valve 99, and the ninth valve 95. Advantageously, that enables the control to cover other supplemental functions. Those include prioritized supplying of oil to the torque sensor 11 before supplying the clutch, and an additional biasing function of the pulleys by raising the tank pressure for the seventh valve 51. For reasons of safety, hydraulic self-retention of the parking lock 25 (with the engine running) is achieved.

Parking lock cylinder 85 operates selector shaft 119 or a parking lock linkage, and is actuated by second valve 89. The resetting is accomplished by the engagement spring 125 acting on the selector shaft 119.

The first valve 71 selects the clutches 19, 21: R (reverse clutch 21 filled), N (both clutches 19, 21 bled), D (forward clutch 19 filled).

The third valve 75 controls the pilot pressure of the first valve 71.

The ninth valve 95 raises the pressure level of the tank return of the seventh valve 51, and is also actuated through the fourth valve 65.

The second valve 89 controls the parking lock cylinder 85, and thus releases the parking lock 25. It contains a hydraulic self-retainer 93. The working pressure is supplied through an OR element 63 from the first or second flow chamber 57, 59 (SS1_adjust or SS2_adjust).

The tenth valve 99 primarily regulates the volumetric flow through the torque sensor circuit 11 (MF circuit). At the same time, at the beginning of the engine startup it sets the volumetric flow so that the torque sensor circuit 11 always includes a minimum volumetric flow available before all other components are supplied.

Actuation of the parking lock 25 is assumed by the second valve 89. When the clutch pressure exceeds a threshold value, disk set SS1 or SS2 adjusting pressure is applied to the piston working surface of the parking lock cylinder 85—the parking lock 25 is disengaged. Second valve 89 goes to self-retention 93.

Ninth valve 95 takes over increasing the tank pressure. It is actuated through fourth valve 65 (cooling pressure regulator). A “stepped” ninth control piston 97 can be used to vary the pressure level above the pilot pressure (pressure return).

The increase in tank pressure causes a uniform increase in the contact pressure of the disk sets, in addition to the set contact pressure of the system pressure valve 49.

That can be employed to capture peaks of torque in critical driving maneuvers (such as ABS deployment).

At the same time, it is also employed to hold the pressure level at a minimum of approximately 6 bar (the holding pressure of the parking lock cylinder 85) during zero crossing of the seventh valve 51. Thus, it provides the hydraulic self-retention 93 of the second valve 89 and of the downstream parking lock cylinder 85.

That enables the parking lock 25 to be kept disengaged even if the power fails while traveling (until the pump 7 comes to a stop=engine off).

The parking lock can be engaged by the engagement spring 125 if:

1. no clutch pressure is applied,

2. the seventh valve 51 is in the middle position (no adjusting pressure), and

3. the ninth valve 95 is in the “no tank pressure increase” position.

That cancels the self-retention, and the second control piston 91 bleeds the parking lock cylinder 85.

The parking lock cylinder 85 is then urged into the “parking lock engaged” position by the engagement spring.

The prioritizing tenth valve 99 supplies the torque sensor 11 with a minimum volumetric flow Q_MFₘᵢₙ (adjustable by means of orifice plate B2) before all other components.

If the set volumetric flow is exceeded, the pressure drop through orifice plate B2 pushes the slide open far enough against the spring until the control edge is at the second flow chamber of the valve.

Then the fifth valve 79 and all other components are also supplied with oil. Almost all the oil flows through the check valve 103 and the orifice plate B1. If the volumetric flow reaches a set limit, the tenth control piston 101 is pushed by the pressure drop at orifice plate B1 into a corresponding limiting-regulating position, at which the surplus volumetric flow is returned to the pump and thus no longer flows through the torque sensor circuit (the tenth valve 99 regulates the total volumetric flow).

The interconnection in the illustrated hydraulic circuit ensures the following safety functions: In the event of a power failure, both clutches are switched automatically to zero pressure; only when the engine is stopped is the parking lock 25 “hydraulically” released (engagement position), since the second valve 89 is able to get out of self-retention 93. (Vehicle 5 is secured against “rolling away” when stopped; while driving, the parking lock 25 cannot catch when the engine is running).

As an additional safety control, a travel/position sensing system 127, 129 is applied to the selector shaft 119 based on the existing sensors. The sensors report to the control device the position and the direction of motion of the selector shaft 119 or of the parking lock slide or cylinder 85.

As additional safety monitoring, a slide travel sensor system 197 based on a Hall-effect sensor 199 is applied to the first control piston 73 (see FIG. 6). The sensors report to the control device the position of the first control piston 73 or the direction of motion during clutch selection. That makes it possible to detect an incorrect selection of the clutches 19, 21, or a hanging of first control piston 73.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for controlling a belt-driven conical-pulley transmission of a motor vehicle, wherein the transmission has a variably adjustable transmission ratio, said hydraulic system comprising:
a first valve arrangement for providing pressurized hydraulic fluid for maintaining a contact pressure between pairs of conical disks and an endless torque-transmitting means of the belt-driven conical-pulley transmission;
a second valve arrangement for providing pressurized hydraulic fluid for controlling the transmission ratio of the belt-driven conical-pulley transmission; and
a hydraulic energy source to supply the hydraulic system with hydraulic energy;
wherein a third valve arrangement is included for providing pressurized hydraulic fluid to control operation of a forward clutch and operation of a reverse clutch.

2. A hydraulic system in accordance with claim 1, including a hydraulic parking-lock release system for controlling a parking lock.

3. A hydraulic system in accordance with claim 1, wherein the third valve arrangement includes a first valve having a control piston for hydraulic actuation of the forward clutch and the reverse clutch.

4. A hydraulic system in accordance with claims 2, wherein the hydraulic parking-lock release system includes a second valve for hydraulic actuation of a parking lock cylinder positioned upstream from the second valve for mechanical actuation of the parking lock.

5. A hydraulic system in accordance with claim 3, wherein the third valve arrangement includes a third valve positioned upstream from the first valve to actuate the control piston of the first valve.

6. A hydraulic system in accordance with claim 3, wherein by means of the control piston of the first valve
a first selector position (R) to apply pressure to the reverse clutch and to switch the forward clutch to zero pressure,
a second selector position (N) to switch the forward clutch and the reverse clutch to zero pressure, and
a third selector position (D) to apply pressure to the forward clutch and switch the reverse clutch to zero pressure,
are selectively alternatively actuatable.

7. A hydraulic system in accordance with claim 6, including a sensor for detecting the first through third selector positions (R, N, D) of the first control piston of the first valve.

8. A hydraulic system in accordance with claim 7, wherein the sensor includes a Hall-effect sensor for detecting a position of the control piston of the first valve.

9. A hydraulic system in accordance with claim 3, wherein the first valve is connected upstream of the hydraulic energy source through a fifth valve.

10. A hydraulic system in accordance with claim 9, wherein the fifth valve is connected downstream to a sixth valve to actuate the fifth valve.

11. A hydraulic system in accordance with claim 9, wherein the second valve arrangement includes a second valve having a control piston, wherein the second valve is connected to the hydraulic energy source through the fifth valve to actuate the second valve.

12. A hydraulic system in accordance with claim 11, wherein the second valve includes a hydraulic latching feature.

13. A hydraulic system in accordance with claim 11, wherein the second valve arrangement includes a seventh valve that is operable to adjust the transmission ratio.

14. A hydraulic system in accordance with claim 13, wherein a first flow chamber and a second flow chamber of the seventh valve are optionally variably connected to adjust the transmission ratio and to one of the hydraulic energy source and the tank.

15. A hydraulic system in accordance with claim 14, wherein the first and the second flow chambers are connected downstream through an OR element to the second valve for providing a hydraulic latching feature.

16. A hydraulic system in accordance with claim 15, wherein the first and the second flow chambers are connected downstream through the OR element and the second valve to a parking-lock release cylinder.

17. A hydraulic system in accordance with claim 14, wherein the first and second flow chambers of the seventh valve are connected through a ninth valve to the tank to raise the tank pressure.

18. A hydraulic system in accordance with claim 17, wherein a control piston of the ninth valve is actuatable through a fourth valve.

19. A hydraulic system in accordance with claim 18, wherein the control piston of the ninth valve includes control steps for controlling an increase of the tank pressure.

20. A hydraulic system in accordance with claim 1, wherein for prioritized supplying of the hydraulic system with hydraulic energy a tenth valve having a control piston is connected downstream from the hydraulic energy source.

21. A hydraulic system in accordance with claim 20, wherein with a first, small amount of hydraulic energy only the first valve arrangement is supplied by the hydraulic energy source, and with a second, larger amount of energy additional components of the hydraulic system are also supplied with hydraulic energy.

22. A hydraulic system in accordance with claim 21, wherein with a third amount of energy that is greater than the second amount of energy, the components of the hydraulic system are supplied with a limited amount of hydraulic energy.

23. A hydraulic system in accordance with claim 1, including a fourth valve arrangement that is provided to control a volumetric flow of cooling oil to cool the clutches.

24. A hydraulic system in accordance with claim 23, wherein the fourth valve arrangement includes a fourth valve for actuation.

25. A belt-driven conical-pulley transmission including a hydraulic system in accordance with claim 1.

26. A motor vehicle including a belt-driven conical-pulley transmission in accordance with claim 25.
